(19) United States
(12) Patent Application Publication
(10) Pub. No.: US 2009/0140660 A1
(43) Pub. Date: Jun. 4, 2009

(54) PULSE-CONTROLLED LIGHT EMITTING DIODE SOURCE

(75) Inventors: Eric R. Fossum, Wolfeboro, NH (US); Grzegorz M. Waligorski, Manhattan Beach, CA (US)

Correspondence Address: DICKSTEIN SHAPIRO LLP, 1825 EYE STREET NW, Washington, DC, 20006-5403, US

(73) Assignee: Aptina Imaging Corporation, Grand Cayman (KY)

(21) Appl. No.: 12/275,937

(22) Filed: Nov. 21, 2008

Related U.S. Application Data
(63) Continuation of application No. 10/421,760, filed on Apr. 24, 2003.
Application No. 10/421,760 is a continuation-in-part of application No. 09/246,013, filed on Feb. 4, 1999, now Pat. No. 6,222,172.
(60) Provisional application No. 60/073,606, filed on Feb. 4, 1998.

(51) Int. Cl. H05B 41/38; H05B 41/16

(52) U.S. Cl. 315/158; 315/250

(57) ABSTRACT

A light-emitting diode array is driven by a digital control. The digital control modulates the pulse width of pulses applied to the light-emitting diode. The intensity of the output is controlled by controlling the width of pulses applied to the light-emitting diode. Since light-emitting diodes have very low inertial energy, this system can be rapidly turned on and turned off. The output is integrated to produce a uniform output.

### CROSS REFERENCES TO RELATED APPLICATIONS

This application is a continuation of U.S. patent application Ser. No. 10/421,760, filed Apr. 24, 2003, which is a reissue application of U.S. patent application Ser. No. 09/246,013, filed Feb. 4, 1999 (U.S. Pat. No. 6,222, 172), which claims the benefit of the U.S. Provisional Application Ser. No. 60/073,606, filed on Feb. 4, 1998, each of which applications is incorporated herein by reference.

### BACKGROUND

Many different image sensors are known in the art. In most cases, the basic function of an image sensor is to produce an electrical response indicative of the intensity of light illuminating its picture elements, or pixels. Each individual pixel contains a light detector, which produces an electrical signal by converting the photons of the incident light to electrons, and accumulating these electrons for a certain period of time. This period of accumulation is often called the integration time, because the process of accumulating light-generated electrons, or photoelectrons, is equivalent to integrating the light intensity over time. Typically, the pixel is exposed to light for its entire integration time, in which case the exposure time and integration time are identical. It is possible, however, to make the exposure time shorter than the integration time by turning off or blocking the light for some part of the integration time.

Generally, the number of photoelectrons collected in the pixel depends on the length of the exposure time and on the intensity of the incident light during that time. A change in one quantity is typically indistinguishable in its effect from a change in the other—both change the amount of light absorbed by the pixel, the number of photoelectrons that are generated, and consequently the electrical response of the pixel. In the particular case when the light intensity is constant throughout the exposure time, the pixel response is simply proportional to both the light intensity and the length of the exposure.

Complete testing of an image sensor requires measuring its various physical characteristics, including the response to different amounts of light. Determination of the dynamic range of the sensor requires varying the amount of light over a comparable, or wider, dynamic range. In most cases, it is difficult to do so by varying the light intensity while keeping the exposure time constant. Light sources typically work well only within a narrow range of output intensities, or change their spectral characteristics when their output intensity is changed. Moreover, the variation of their output intensity within the available dynamic range is typically nonlinear. An alternative to changing the light source output is to use an external light intensity attenuator. The throughput of such a device usually cannot be continuously and precisely varied. In contrast, it is relatively easy to control the exposure time of the sensor with high precision. As stated above, changing the duration of the sensor's exposure to a constant light level causes a proportional change in its response. Hence, varying the exposure time instead of the light intensity has often been the preferred method of measuring such sensor parameters as dynamic range, linearity, signal-to-noise ratio, and conversion gain.

Traditional incandescent light sources have large thermal inertia. This slows their response to power supply interruptions. Therefore, it is difficult to effectively vary the time of the sensor's exposure to light from such a source by interrupting the operation of the source. Typically, a more accurate exposure control is achieved by fast shuttering of the continuously emitted light.

### SUMMARY

The present specification describes a light source which does not have these drawbacks. This light source uses light emitting diodes with controllable output parameters. Light-emitting diodes are orders of magnitude faster in their response to voltage-supply interruptions than incandescent light sources. Typically, a light-emitting diode has a rise-and-fall time below 1microsecond. This makes it possible to precisely control the sensor's exposure time.

According to a preferred mode, an LED array is powered with a periodic rectangular voltage waveform whose duty cycle is digitally controlled. A system is described herein which allows achieving a three-decade dynamic range of exposure time for integration times below a thirtieth of a second.

### BRIEF DESCRIPTION OF THE DRAWINGS

These and other aspects of the invention will be described in detail with respect to the accompanying drawings, wherein:

FIG. 1 shows a schematic diagram of the light source used according to the present mode;

FIG. 2 shows a block diagram of the LED driver;

FIGS. 3-5 show results of driving the LED driver using the device described according to the preferred mode; and

FIG. 6 shows three semiconductor dies in the same package.

### DESCRIPTION OF THE PREFERRED EMBODIMENTS

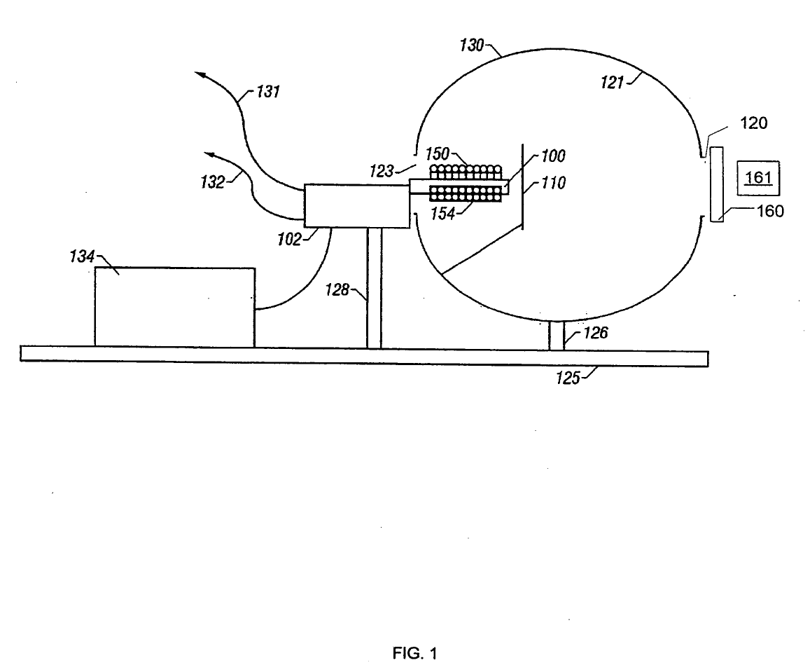

The light emitting array uses a light source that has a very small thermal inertia, and hence permits a very fast response time, e.g., less than 10 μs, and more preferably on the order of 100 ns. That is, the light emitting array uses a source that is capable of initiating and terminating a light burst within 100 ns of the appropriate change in the voltage applied to the source. The preferred mode uses a LED array 100 that has the general layout shown in FIG. 1. Specifically, the LED array includes four different types of LEDs, each type emitting in a different part of the electromagnetic spectrum.

There are preferably six LEDs 150 which emit infrared radiation. Three groups of eighteen LEDs, 152, 154, and 156, emit respectively in the red, green, and blue regions of the visible spectrum. The combination of three primary colors, red, green, and blue, is preferred, but more generally, other LEDs emitting light of other colors could be used instead. The LEDs are driven by a LED driver 102 which is described in further detail herein.

The LED array is a bar-shaped part with the LEDs mounted in six parallel rows in such a way that they emit light in three directions perpendicular to the axis of the bar. If the axis is aligned horizontally as in FIG. 1, the two rows of LEDs on top of the bar emit vertically upward, while the LEDs in the pairs of rows on the left and right side of the bar emit in the directions that are 120 degrees with respect to the vertical and to each other. Each row of LEDs contains a single infrared LED and three LEDs of each primary color, giving a total of ten LEDS per row. In each row, the nine red, green, and blue LEDs are arranged in the sequence, RGBRGBRGB, to provide improved color mixing.

The LED array is fully inserted into an integrating sphere 130 through its 1″ diameter input port 123. The integrating sphere 130 is a hollow sphere of cast aluminum with a layer of white reflecting material on its interior surface. This is a high reflectivity material, which however does not reflect light specularly, but instead diffuses it in all directions. The integrating sphere is preferably 8″ in diameter. These integrating spheres are commercially available.

Integrating sphere 130 integrates the light output from the LED array and acts as an efficient light diffuser. That is, the light from all of the LEDs is mixed by multiple reflection and diffusion within the integrating sphere 130. By the time the light reaches the output port 120, it is effectively uniform in color and intensity. This uniform light output can be used to illuminate the entire pixel arrays of image sensors, with spatial nonuniformity less than 1% across a 2×2 cm array.

The integrating sphere is held on a base plate 125 by a supporting post 126. In the preferred mode, the same base plate 125 also holds the LED driver 102 via another post 128. The LED array 100 in this embodiment is physically attached to and supported by the LED driver 102, although it can be spaced therefrom.

A circular-shaped light baffle 110 separates the LED array 100 from the output port 120. The baffle blocks all direct beam paths from the LEDs to the output port, so that light emitted by the LEDs can reach the output port only by multiple reflection from the inner surface of the integrating sphere. The light baffle is held within the integrating sphere by supports 109. This light baffle is a standard part of commercially available 8″ integrating spheres.

The LED driver is controlled by a personal computer via a five-line connection 132. The LED driver also has a connector 131 for an optional gating signal. The power for the LED driver and LED array is provided by a commercially available 5V DC power supply 134. The preferred embodiment of the LED array has all LEDs connected in parallel so that the maximum voltage across each LED can be as high as 5V. However, each type of LED used therein has a different optimal working voltage, varying from about 1.8 V for red LEDs to about 3.6 V for blue LEDs. The LED driver 102 converts 5V control signals received from the PC to these optimal voltages, supplying to each LED the optimal working current of about 20 mA. Each drive to each LED, however, is either on or off, and is hence digital in the sense that it is either on or off.

If access to the LED array is required, the entire assembly 100/102 can be detached from the post 128, and removed from the integrating sphere.

The personal computer 200 controls the amount of light emitted by each LED by controlling the duty cycle of the rectangular voltage waveform driving the LED rather than by controlling the voltage driving the LED. The voltages driving the LEDs are switched between high and low levels, alternately turning the LEDs ON and OFF. The duty cycle is the ratio of the light pulse width (the duration of the ON phase) to the full period of the driving waveform (the sum of the ON and OFF phases). Therefore, the LEDs emit more light when their duty cycle approaches one, and less light when the duty cycle approaches zero. In the preferred embodiment the light pulse width is constant and identical for all LEDs. Its preferred value is 1 to 2 us. The duty cycle of each LED is varied by changing the duration of its OFF phase only. The total energy of light emitted during one video frame, i.e., 1/30 of a second, can be linearly varied over a dynamic range of up to 1,000.

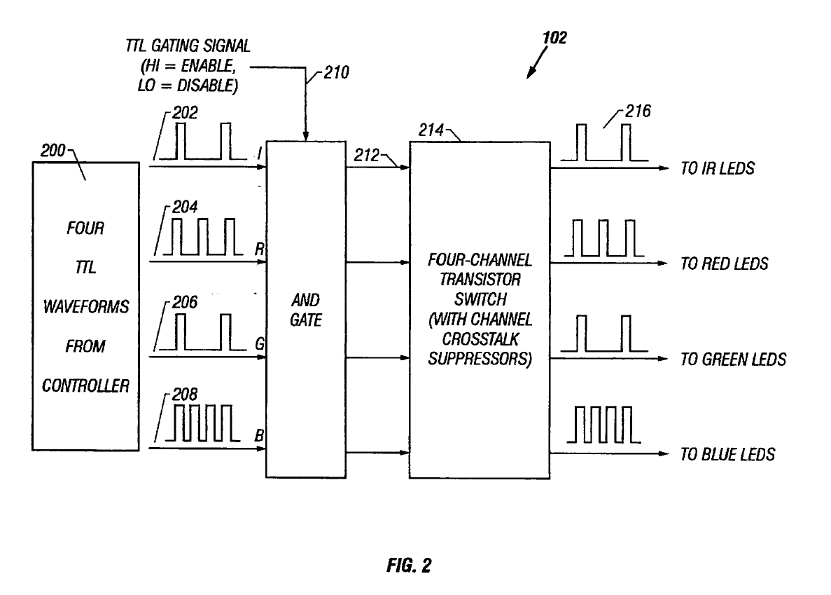

Even though the controller 200 is shown in FIG. 2 as a personal computer, any device capable of outputting several independent waveforms of appropriate voltage level can be used instead. In the preferred mode each control waveform is a uniform train of rectangular 5V pulses. Other waveforms can also be generated by the controller and applied to the inputs of the LED driver In FIG. 2, the signal line 202 controls the infrared LEDs, and lines 204, 206, and 208 correspond respectively to red, green, and blue drivers. As shown, the control signal on each line may have a duty cycle different from other signals. The control is digital in a dual sense: first because each control waveform has only two voltage levels and secondly because the duration of the low and high voltage phases is digitally controlled.

As an option, each of the waveforms applied to the control inputs of the LED driver may be gated by an optional TTL signal 210 applied to the input 131. The gating is done by combining each control signal with the gating signal 210 in an AND gate. The control signal is allowed to pass through the gate only when the gating signal 210 is high.

214 represents a set of four transistor switches with some circuitry suppressing cross-talk between the control channels. Each switch is toggled by a TTL control waveform, and in turn toggles a set of same-color LEDs in the LED array, making them operate together as a strobe light. The time-averaged output power of this strobe light, P, is proportional to the duty cycle, Q, of the controlling pulse train. If Q is not allowed to exceed ½, the dynamic range of the energy that can be emitted by the strobe light in time T is equal to T/2t, where t is the light pulse width. The minimum t is determined by the response time of the LEDs, which is on the order of 100 ns. A set of values through which P and Q can be stepped is determined by the smallest time increment allowed by the controller 200. If this time increment is d, the duty cycle can be stepped through a series Qn=t/(2t+nd), where n=0, . . . The smallest step that can be made on the Q and P scales is therefore not equal at all points, but varies with Q, approximately as Q2d/t.

In the preferred mode the optimal light pulse duration is 1 to 2 ms. These values have been found to give the best P vs. Q linearity for Q [symbol] ½. They also provide sufficient dynamic range of P for testing image sensors at a 30 frames/s acquisition rate. All the control waveforms are generated by a counter-timer board installed in the controller 200. The board is preferably either an AT-MIO-16X or a PC-TIO-10, each commercially available from National Instruments. The smallest time increment for these devices is 200 ns.

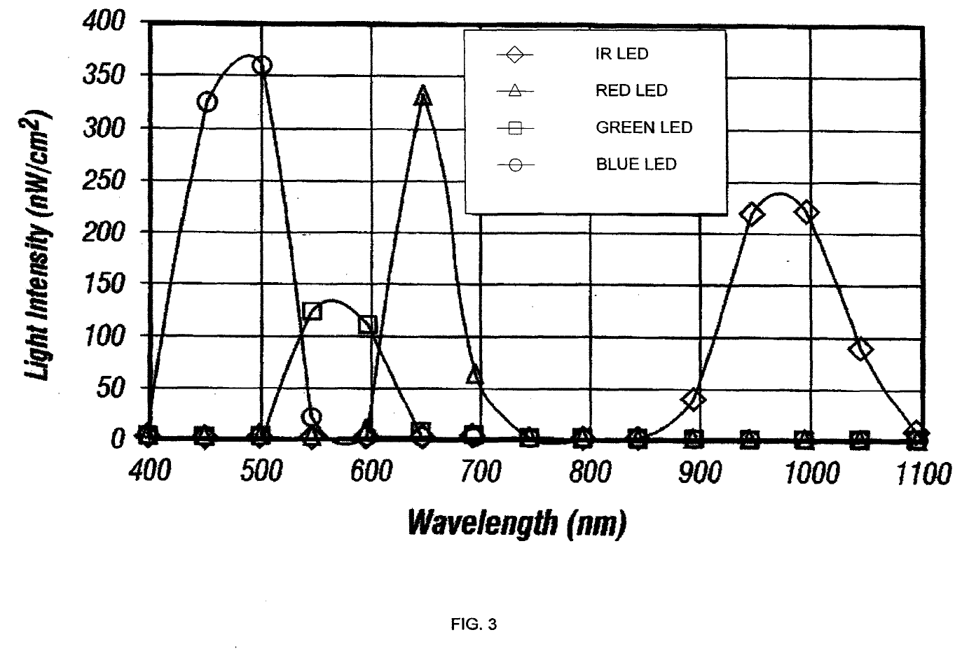

FIGS. 3, 4, and 5 show the essential characteristics of the preferred light source: the emission spectra of the LEDs, the P vs. Q linearity, and the spatial uniformity of the output. The spectral curves in FIG. 3 should be used for general orientation only. These were obtained using a set of narrow-band filters spanning the 400-1100 nm wavelength range in 50 nm steps. These filters have varying bandwidths (10-40 mn) and peak transmittances (50-70%), whose effect on the measured light intensities has not been corrected. The filters (160 of FIG. 1) were placed between the circular 2″ diameter output port of the integrating sphere and a calibrated Melles-Griot 13DSI011 photodiode (161 of FIG. 1) whose circular 1 cm2 active area was coaxial with the output port. The average power of light incident on the active area was taken as the light intensity to be plotted in FIG. 3.

The duty cycle range of the photodiodes should be determined for each device. The most linearity is obtained if the photodiode is never saturated by the driving.

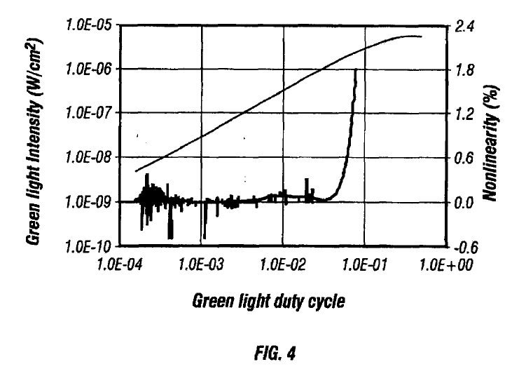

The time-averaged intensity of light from the green LEDs plotted in FIG. 4 was measured using the same setup, but with no filter between the output port and the photo diode. The distance, d, from the plane of the output port to the surface of the photo diode's active area was equal to 5 mm. The light intensity measured at distances d<15 mm is nearly independent of d. Farther on the axis of the output port (optical axis) the intensity decreases like 1/d².

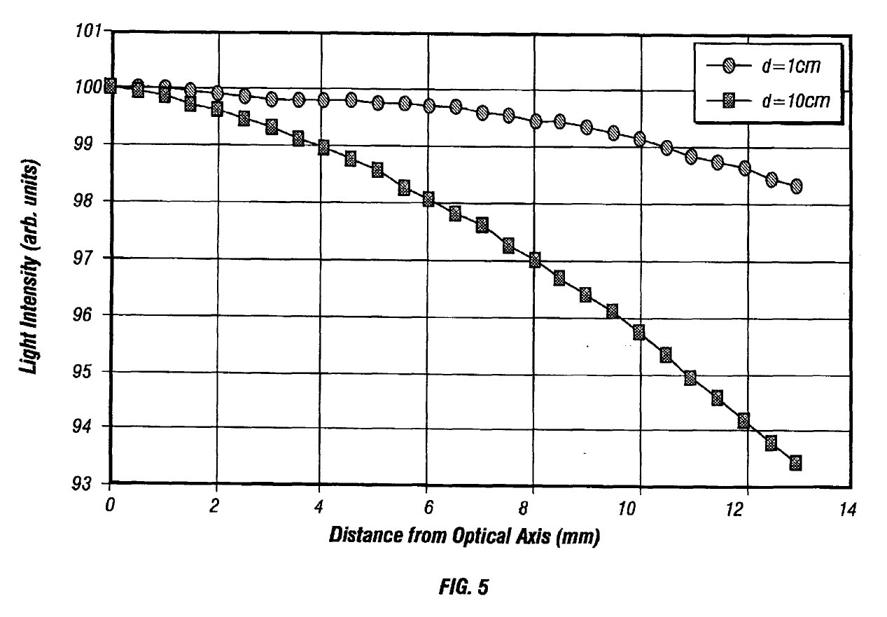

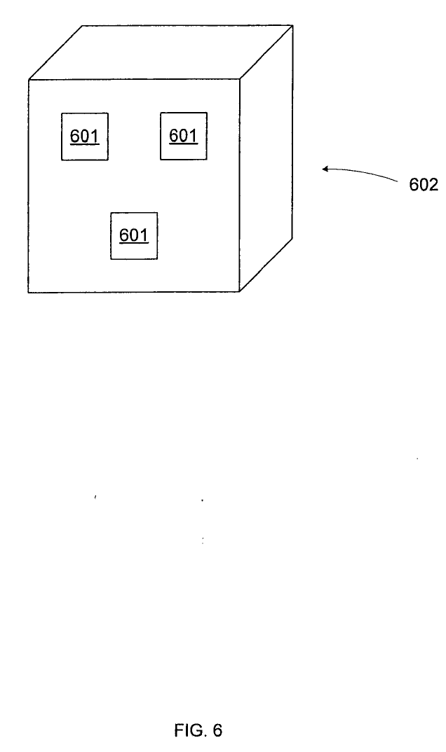

FIG. 5 shows the uniformity of illumination of two planes perpendicular to the optical axis, at d=1 cm and d=10 cm. The intensity of incident light was averaged over a circular 1-mm-diameter aperture, whose center was at a distance r=0 to 12 mm from the optical axis. Importantly, the LED has three semiconductor dies 601 of FIG. 6 in a single package 602. The light of each color mixes very well with the other colors.

Although only a few embodiments have been described in detail above, other embodiments are contemplated by the inventor and are intended to be encompassed within the following claims. In addition, other modifications are contemplated and are also intended to be covered. For example, other integrating mechanisms besides the integrating sphere described herein can be used. The LED package can also be modified. Preferably, the LEDs are facing away from the output port so that light mixing is optimized. Different colored LEDs can be used, and in fact a single LED could be used.

For example, while an LED has been described as the preferred light source used herein, it should be understood that any light source with very low thermal inertial could alternatively be used. Moreover, other colors besides those specifically described here, and other values for timing, could also alternatively be used. All such modifications are intended to be encompassed within the following claims.

1-12. (canceled)

13. A controllable light source, comprising:
at least three light emitting diodes contained in a single package, each having a different characteristic of output light
wherein the three light emitting diodes are arranged within a row, the row comprising a plurality of red LEDs, a plurality of green LEDs, and a plurality of blue LEDs, and wherein the light integrator is configured to diffuse light from the row;
a controller for the light emitting diodes that produces a pulse-width modulated control pulse having an on state and an off state;
a brightness controller, controlling said controller to produce longer on states for higher brightness, and shorter on states for lower brightness; and
a light integrator having the light emitting diodes disposed therein to integrate light output from the light emitting diodes, wherein the light integrator includes an output port from which the integrated light is output.

14. The light source of claim 13, wherein the red, green, and blue LEDs are interspersed with one another within the row to facilitate color mixing.

15. The light source of claim 14, further comprising:
a circuit configured to collectively control a brightness of the three light emitting diodes together;
wherein the brightness controller is configured to separately adjust a first signal, a second signal, and a third signal, wherein the first signal is coupled to control a brightness of the plurality of red LEDs, the second signal is coupled to control a brightness of the plurality of green LEDs, and the third signal is coupled to control a brightness of the plurality of blue LEDs.

16. The light source of claim 15, wherein the circuit comprises a first logic configured to combine the first signal with a control signal, a second logic configured to combine the second signal with the control signal, and a third logic configured to combine the third signal with the control signal.

17. The light source of claim 15, further comprising a light detection unit disposed to receive light mixed from the plurality of red, green, and blue LEDs, and configured to indicate an intensity of red light, an intensity of green light, and an intensity of blue light emanating from the red, green, and blue LEDs.

18. The light source of claim 17, wherein the light detection unit is not saturated.

19. The light source of claim 17, further comprising at least one color filter adjacent to the output port and configured to filter light exiting the output port.

20. A method of controlling a light source comprising:
controlling an intensity of a first red LED responsive to a first input signal that controls an intensity of a plurality of red LEDs, including receiving a gating signal at a first input of a first logic circuit and receiving the first input signal at a second input of the first logic circuit and activating and deactivating the red LED in response to a signal at an output of the first logic circuit to thereby control an intensity of the first red LED;
controlling an intensity of a first green LED responsive to a second input signal that controls an intensity of a plurality of green LEDs, including receiving the gating signal at a first input of a second logic_circuit and receiving the second input signal at a second input of the second logic_circuit and activating and deactivating the green LED in response to a signal at an output of the second logic_circuit to thereby control an intensity of the first green LED;
controlling an intensity of a first blue LED responsive to a third input signal that controls an intensity of a plurality of blue LEDs, including receiving the gating signal at a first input of a third logic circuit and receiving the third input signal at a second input of the third logic circuit and activating and deactivating the blue LED in response to a signal at an output of the third logic circuit to thereby control an intensity of the first blue LED; and
diffusing light from the plurality of red, green, and blue LEDs,
wherein the first red LED, the first green LED, and the first blue LED are formed in a single package.

21. The method of claim 20, further comprising emitting the light from the plurality of red, green, and blue LEDs primarily away from the output port.

22. The method of claim 20, further comprising providing the gating signal, the first input signal, the second input signal, and the third input signal from a personal computer.

23. The method of claim 20, further comprising receiving the light from the plurality_of red, green, and blue LEDs at an array of pixels.

24. The method of claim 23, further comprising
receiving the light from the plurality of red, green, and blue LEDs at a light detection device.

25. The method of claim 23, further comprising filtering the light from the plurality of red, green, and blue LEDs through a color filter.

26. The method of claim 20, further comprising filtering the light from the plurality of red, green, and blue LEDs through red, green, and blue color filters.

27. A system comprising:
a light source comprising a first LED, a second LED, and a third LED, disposed in a single package;
a power supply;
a driver circuit configured to couple the power supply to the light source and to adjust an intensity of light from the light source by providing a first duty cycle of a first waveform configured to drive the first LED, a second duty cycle of a second waveform configured to drive the second LED, and a third duty cycle of a third waveform configured to drive the third LED;
a first control circuit coupled to the driver circuit and configured to provide a first signal to control the first duty cycle, a second signal to control the second duty cycle, and a third signal to control the third duty cycle, wherein the first, second, and third signals are distinct from each other;
a diffuser to diffuse light from the first, second, and third LEDs to produce a diffused light at an output port; and
at least one color filter adjacent to the output port configured to pass through colored light from the diffused light.

28. The system of claim 27, further comprising:
a red color filter configured to pass through red light from the diffused light;
a green color filter configured to pass through green light from the diffused light; and
a blue color filter configured to pass through blue light from the diffused light.

29. The system of claim 27, wherein the first LED, the second LED, and the third LED have different characteristics of output light.

30. The system of claim 27, further comprising a pixel array disposed to receive light from the light source.

31. The system of claim 30, further comprising:
a second control circuit configured to provide a control signal to control the first, second, and third duty cycles;
a first circuit configured to combine the control signal with the first signal to control the first duty cycle;
a second circuit configured to combine the control signal with the second signal to control the second duty cycle; and
a third circuit configured to combine the control signal with the third signal to control the third duty cycle.

32. The system of claim 31, wherein the the second control circuit is further configured to provide the control signal to control duty cycles of all waveforms configured to drive all LEDs in the light integrator, including the first, second, and third LEDs.
